(19) United States
(12) Patent Application Publication
(10) Pub. No.: US 2025/0030153 A1
(43) Pub. Date: Jan. 23, 2025

(54) DIELECTRIC SUPPORT THREADS FOR SATELLITE ANTENNA RADIATING ELEMENTS AND OTHER PAYLOADS

(71) Applicant: MacDonald, Dettwiler and Associates Corporation, Sainte-Anne-de-Bellevue (CA)

(72) Inventors: Stephane Lamoureux, Mirabel (CA); Steve Larouche, Saint-Lazare (CA); Gérard Sénéchal, Ste-Anne-de-Bellevue (CA); Xavier Bry-Marfaing, Vaudreuil-sur-le-lac (CA); Alexandre Mousseau, Verdun (CA); Santiago Sierra-Garcia, Montreal (CA)

(21) Appl. No.: 18/770,113

(22) Filed: Jul. 11, 2024

Related U.S. Application Data
(60) Provisional application No. 63/514,492, filed on Jul. 19, 2023.

(51) Int. Cl. H01Q 1/28; H01Q 1/36

(52) U.S. Cl. CPC H01Q 1/288; H01Q 1/36

(57) ABSTRACT

Provided are systems and methods for a radiating element assembly, for an antenna. The radiating element assembly includes a radiating element for emitting and/or receiving electromagnetic waves and a radiating element support system for physically supporting the radiating element when in operation. The radiating element support system includes a plurality of dielectric support threads, where the plurality of dielectric support threads act as non-linear structural links which interconnect the radiating element to constrain the radiating element in one or more of an axial direction, radial direction, and torsional direction, and the plurality of dielectric support threads are taut with near zero tension, and at least one support wherein the plurality of threads interconnect the radiating element with the at least one support to constrain the radiating element in the axial and/or radial and/or torsional directions. The radiating element support system may be used to constrain other satellite payloads.

### TECHNICAL FIELD

The following relates generally to antenna systems, and more particularly to support structures for satellite antenna radiating elements.

### INTRODUCTION

In the aerospace industry, global coverage antennas, shaped beam antennas and omni-directional antennas are typically mounted on spacecraft structures to allow unencumbered communications to and from other points of communication. These types of antennas typically include at least one radiating element wound around an elongated dielectric supporting structure which has a negligible effect on the transmission of radiofrequency (RF) waves. This structure provides support to the flexible radiating element during launch and maintains the shape of the radiating element once in orbit operation.

The impact of the dielectric supporting structure on RF performances is a function of the bulk volume it occupies within the antenna electro-magnetic field, as the dielectric material of the supporting structure may influence the radiation pattern of the antenna, cause power losses, and lead to sudden electro-static discharges (ESD) which can damage the payload and render the antenna non-operational.

Current satellite radiating element assemblies have a number of structural issues. The supporting elements are separate from the radiating element and therefore require additional elements such as adhesive or other forms of bonding to connect to the radiating element and provide support. The materials which are used for making these connections often have limited power carrying capability. Typically, a metallic radiating element is bonded (Epoxy) to a dielectric support structure (made of fiberglass fibers, aramid fibers like Kevlar™ or NOMEX™, polyimide like Kapton™, or the like). Current methods of manufacturing satellite radiating element assemblies are time-consuming and costly, with the need to connect various flexible (non-rigid) components of the antenna system complicating the method of assembly of the system.

Additionally, all exterior surfaces of an antenna assembly must survive exposure to space over the mission lifetime preferably without the need for a sunshield.

Accordingly, there is a need for an improved antenna assembly and antenna radiating element support system that overcomes at least some of the disadvantages of existing systems and methods.

### SUMMARY

Provided herein is a radiating element assembly, for an antenna, including a radiating element for emitting and/or receiving electromagnetic waves and a radiating element support system for physically supporting the radiating element when in operation. The radiating element support system includes a plurality of dielectric support threads that act as non-linear structural links which interconnect the radiating element to constrain the radiating element in one or more of an axial direction, a radial direction, and a torsional direction, and that are taut with near zero tension. The radiating element support system further includes at least one support. The plurality of dielectric support threads interconnect the radiating element with the at least one support to constrain the radiating element in the one or more of the axial direction, the radial direction, and the torsional direction.

The at least one support may include a central support positioned within the radiating element.

The central support may be fixed to a ground plane at a base of the antenna.

The central support may be rigid in tension, compression, bending, and torsion.

The at least one support may include at least one external support positioned external to the radiating element.

The at least one support may include a central support within the radiating element and at least one external support position external to the radiating element.

The radiating element and the central support may be manufactured as a single piece.

The radiating element may be helical.

The radiating element may be flexible due to a shape of the radiating element.

The radiating element support system may prevent movement of the radiating element beyond a correct nominal position.

Each of the dielectric support threads may have a thread diameter in the range of 0.005 to 0.050 inches.

The dielectric support threads may comprise a radiofrequency (RF) transparent material.

The dielectric support threads may comprise glass or aramid fibers.

Each dielectric support thread may comprise two or more strands twisted together.

A satellite payload assembly is also provided. The satellite payload assembly includes a payload of a satellite and a payload support system for physically supporting the payload. The payload support system includes a plurality of dielectric support threads that act as non-linear structural links which interconnect the payload to constrain the payload in one or more of a radial direction, a torsional direction, and an axial direction, and that are taut with near zero tension. The payload support system also includes at least one support. The plurality of dielectric support threads interconnect the payload with the at least one support to constrain the payload in the one or more of the radial direction, the torsional direction, and the axial direction.

The at least one support may include a central support positioned within the payload.

The central support may be fixed to a ground plane at a base of the payload.

The at least one support may include at least one external support positioned external to the payload.

The at least one support may include a central support within the payload and at least one external support position external to the payload.

The payload may be a waveguide.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1A is a side perspective view of an antenna assembly with a radiating element support system, according to an embodiment;

FIG. 1B is a side perspective view of a tip section of the antenna assembly of FIG. 1A in isolation;

FIG. 1C is a side perspective view of a base section of the antenna assembly of FIG. 1A in isolation;

FIG. 1D is a top view of the antenna assembly of FIG. 1A;

FIG. 2 is a side perspective view of an antenna assembly with a radiating element support system, according to an embodiment;

FIG. 3A is a side perspective view of an antenna assembly with a radiating element support system, according to an embodiment;

FIG. 3B is a top view of the antenna assembly of FIG. 3A, according to an embodiment; and

FIG. 4 is a side perspective view of a single piece radiating element and central support, according to an embodiment.

FIG. 5 is a simplified block diagram of an antenna assembly including a radiating element support system with external supports, according to an embodiment.

FIG. 6 is a simplified block diagram of a waveguide of a satellite assembly including a waveguide thread support system, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Further, although process steps, method steps, algorithms or the like may be described (in the disclosure and/or in the claims) in a sequential order, such processes, methods, and algorithms may be configured to work in alternate orders. In other words, any sequence or order of steps that may be described does not necessarily indicate a requirement that the steps be performed in that order. The steps of processes described herein may be performed in any order that is practical, and in some cases certain steps of processes may be omitted. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to antenna systems, and more particularly to antenna radiating element support systems for use within satellite antenna assemblies.

The radiating element support systems described herein can be used to support radiating elements which have a helical shape and are, therefore, flexible. That is, the material(s) which the radiating element comprises may not be flexible but overall, the radiating element is inherently flexible due to the helical shape. In other embodiments, the radiating element support system may be employed for radiating elements that do not have a helical shape or form, but which are flexible and therefore require support. Herein, use of the term “helical”, “helix”, “helical shape” or similar, or discussion of embodiments wherein the radiating element is a helix are not meant to limit the assemblies and systems to only those including helical radiating elements.

The physical characteristics of the helix, such as diameter and pitch must be maintained for proper functioning of the antenna within its intended performance envelope throughout the on-ground testing under gravity, launch under vibration and on-orbit life. Deformation under gravity could impact the on-ground antenna performance measurements. To survive the vibrations during testing and launch phases, the radiating element requires support to prevent movement of the helix (or other shape) out of the correct nominal position in axial, radial, and torsional directions. Large deformations during vibrations could lead to failure of the radiating element.

The radiating element support system of the present disclosure prevents the movement of the helix out of the correct nominal position using small diameter RF-dielectric support threads which, in some embodiments, connect the helix to a rigid central support at multiple locations and, in other embodiments, connect the helix to at least one external support structure at multiple locations. The central support must be rigid enough to provide sufficient constraint in limiting the displacement of the radiating elements in the required directions. In some embodiments, the radiating element may be connected to both central and external supports. The dielectric material is non-conductive and thus has a negligible impact on the radiated fields of the antenna. The thread diameter is minimized—in the range of 0.005″ to 0.050″ diameter—in order to further decrease the impact on the radiated fields of the antenna along with minimizing the on-orbit bulk charging of the dielectric material which could lead to electro-static discharges. The thread material may be “RF transparent”, wherein “RF transparent” means the material has a negligible effect on the transmission of RF waves and, therefore, does not impact the performance of the antenna (e.g., does not impact emission or reception of electromagnetic waves). The thread material may be, for example, glass or aramid fibers (e.g., Nomex®). The dielectric threads are preferably made of 2 or more strands twisted together. The non-homogenous nature of the thread made of twisted yarns, along with the small diameter and stiffness lead to compliance when compressed to avoid failure under buckling which could occur during vibration while still being stiff in tension.

During assembly, the dielectric support threads are taut, not tensioned, to provide a consistent stiffness though testing, launch and on-orbit life. That is, the dielectric support threads should have near zero tension—within an envelope that is achievable considering assembly operations and consistent with viscoelastic creep minimization (e.g., on the order of 20 grams tension). If the support threads were significantly tensioned the stiffness would not be consistent due to viscoelastic creep which could occur over time. The support threads act as non-linear structural links during the vibration phase as they constrain movements of the radiating element when the threads are under tension but allow the radiating element to move when under compression (i.e., the threads support the radiating element in one direction, tension of the thread, but not the other direction, compression of the thread). The overall thread configuration is optimized relative to the radiating element geometry so as to provide sufficient stiffness and strength so that the antenna can survive vibrations along all directions applied at the base of the antenna. The assembly stiffness (of the support, threads, and radiating element) is obtained by ensuring that the radiating element is constrained by threads in axial and/or radial and/or torsional directions by at least 2 threads so at least one is acting in tension at any given time. The thread configuration may or may not need threads to constrict the helix torsional movements depending on the geometry, size, and vibration requirements of the antenna.

In order to provide a support interface for the threads constraining the radiating element, the antenna assembly may include a central support which is fixed to the ground plane at the antenna base. This central support is shaped and sized to minimally affect the antenna radiating performances while being stiff enough in tension, compression, bending and torsion to support the radiating element and threads during on-ground measurements, vibration testing, launch and on-orbit operations. The support threads interconnect the radiating element and the central support and may also interconnect the radiating element to the radiating element.

In embodiments where the antenna assembly includes at least one external support the external support acts in the same manner as a central support, minimally affecting the antenna radiating performance while being stiff enough in tension, compression, bending and torsion to support the radiating element and threads during on-ground measurements, vibration testing, launch and on-orbit operations.

That is, the support for the radiating element can be central (within the radiating element) or external (outside of the radiating element), as long as a stiff local support is present for attaching threads which support the radiating element in the radial plane of the helix. As above, in some embodiments there may be central and external supports.

The support threads interact jointly with the rigid central support or external support, providing bending stiffness and limiting motion of the helix itself. The central support is stiff in tension, compression, bending, and torsion which helps limit the main bending modes of the assembly. The support threads limit local helix modes, in helix axial and/or radial and/or torsional directions, as the thread network stiffens the helix at the thread interface location where the thread meets the helix. The thread network may also constrain the helix in the torsional direction to help mitigate assembly behavior impacts caused by helix torsional modes.

The radiating element must include an electrically conductive material. In some embodiments the radiating element may comprise entirely an electrically conductive material. In other embodiments the radiating element may comprise non-electrically conductive material which is coated with an electrically conductive material. The radiating element may be a metal, e.g., aluminum.

In some embodiments, the radiating element and the central support may be manufactured as a single piece. This process may save time and decrease costs compared to manufacturing the radiating element and central support as two or more pieces.

In some embodiments, manufacturing or constructing the antenna assembly may include three dimensional (3D) printing the radiating element alone or with the central support. For example, the radiating element and central support may be 3D printed as a single piece using aluminum.

In embodiments where the central support is manufactured separately from the radiating element, the central support may be the same or different material as the radiating element.

As discussed above, current antenna assemblies have several shortcomings. Bulky dielectric support structures interfere with the antenna radiating pattern and increase power losses. Electric charging while on-orbit may lead to sudden electro-static discharge (ESD) impacting the ability of the antenna to operate, for example limiting or stopping the ability of the antenna to emit and/or receive electromagnetic waves.

Existing forms of supporting elements for antenna radiating elements can require adhesive or other forms of bonding to connect to the radiating element and provide support. The materials which are used for making these connections often have limited power carrying capability. For example, parts of the supporting structure may be made of Kapton™. The need to connect various flexible components of the antenna system complicates the method of assembly of the system, is time consuming and is costly. Additionally, surfaces of dielectric support may need to be protected from exposure to space, via a semi-conductive coating over the dielectric support material and/or a sunshield.

The present disclosure provides solutions to these problems. The use of small dielectric threads to support the radiating element mitigates RF performance issues and ESD risks. The dielectric threads can be made of a material (e.g., glass or aramid fibers) which can be exposed to the environment of space, removing the requirement for coating, and potentially removing the requirement for a sunshield depending on the orbit. The radiating element and central support can be 3D printed as a single piece to minimize costs and reduce complexity and time when installing the dielectric threads.

The technical solution provided herein can be used in various antenna applications with radiating elements of different sizes and shapes and may be particularly useful for high power applications.

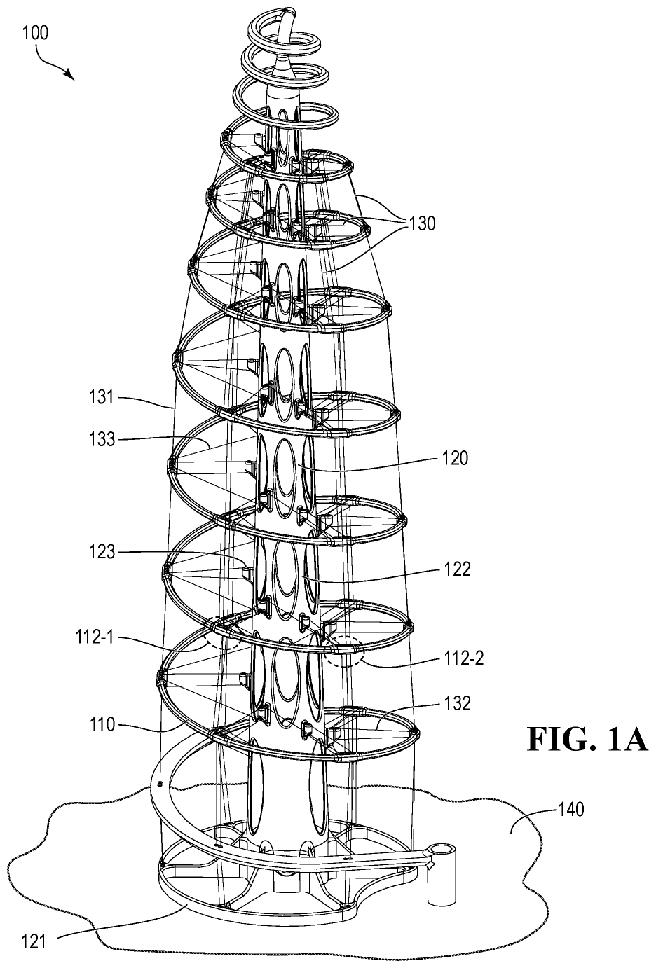

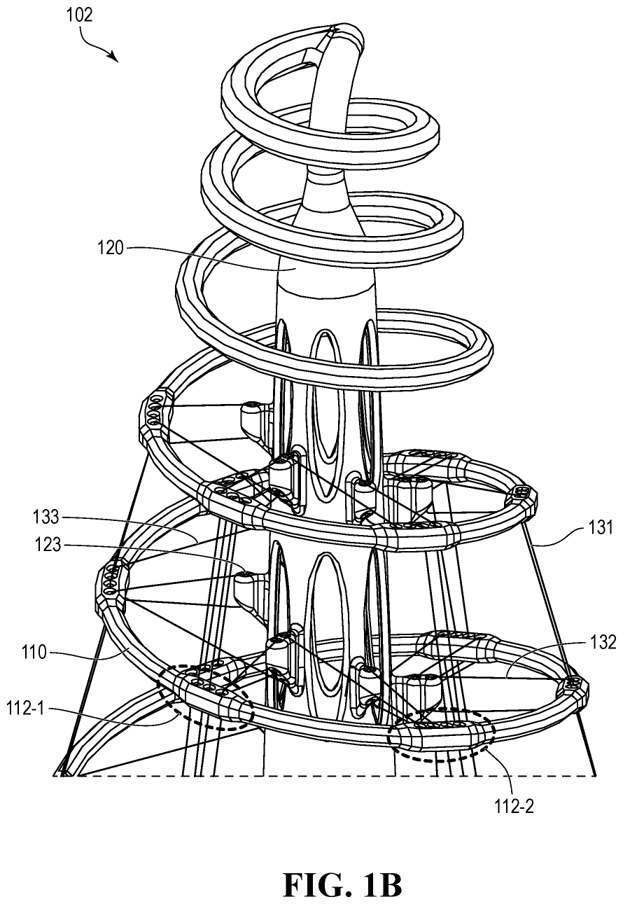

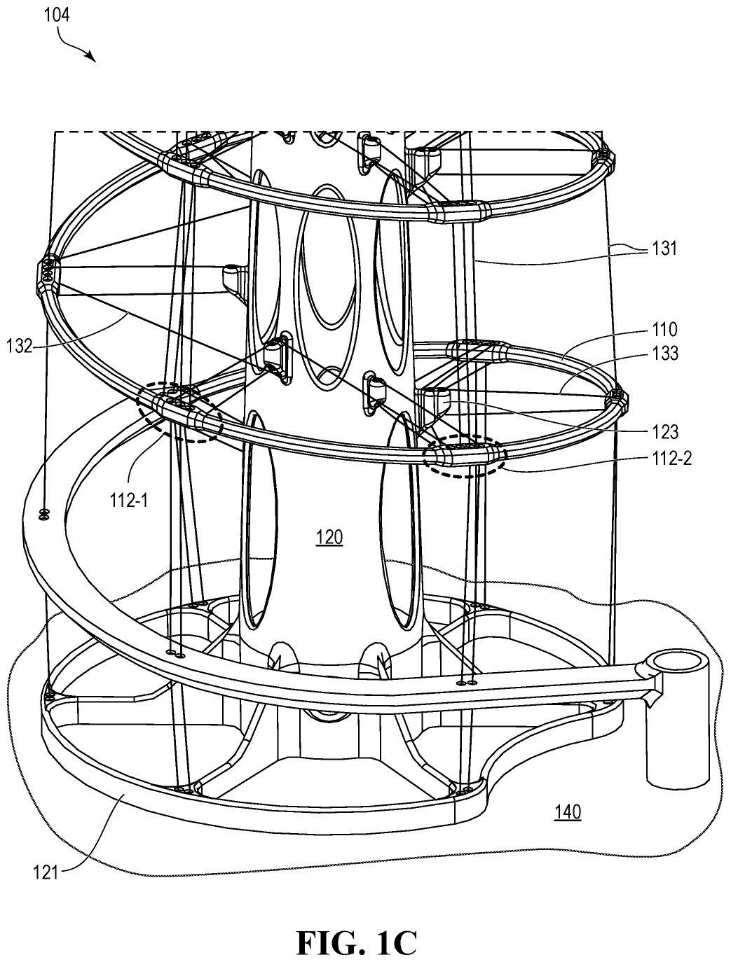

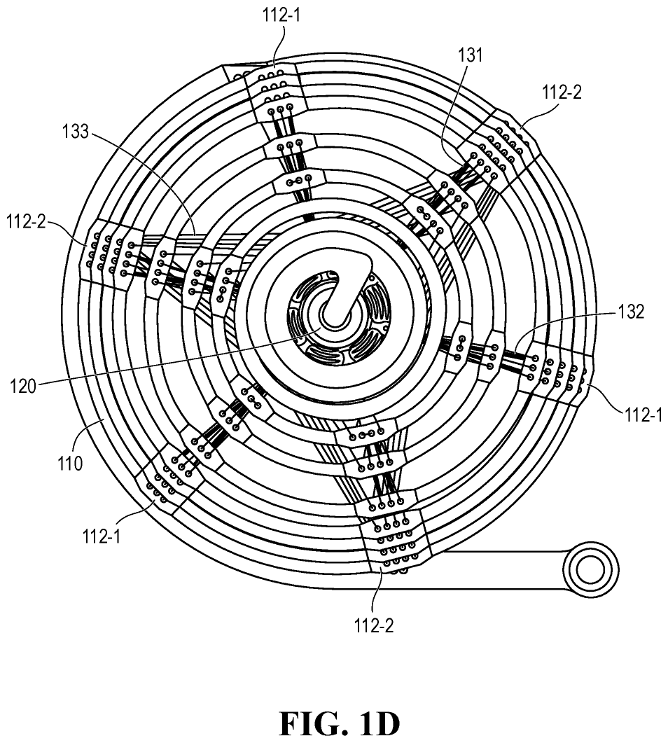

Referring now to FIGS. 1A-1D, shown therein are various views of an antenna assembly 100 including a radiating element support system, according to an embodiment. The antenna assembly 100 may be used in an antenna configured for satellite-based communication.

The antenna assembly 100 includes a radiating element 110, and a radiating element support system comprising a rigid central support 120, and a plurality of support threads 130 (only three labelled to reduce clutter). The plurality of support threads 130 may also be referred to as a support thread network.

In the embodiments shown in FIGS. 1A-D and 2 below, the threads of the support thread network are attached to the radiating element and the central support through holes present in the radiating element and support. The threads pass through the holes and are connected to the radiating element and support within the holes using adhesive. In other embodiments any mechanism for attaching threads to the radiating element and the support may be contemplated. For example, in some embodiments the thread may be connected to an exterior surface of the radiating element or support by adhesive or other means of bonding. In other embodiments, the threads may wrap around the radiating element and the support. In some embodiments, adhesive or other type of bonding is not used. In some embodiments, different threads may be connected to the radiating element and supported by different means of connection, including but not limited to those mentioned above.

In the embodiments shown in FIGS. 1A-3B, often a single thread is shown as interconnecting several turns of the helix. However, in other embodiments multiple pieces of thread may be used to accomplish the same support, wherein a single piece of thread connects a turn to an adjacent turn and therefore multiple threads are used to provide support to the helix in the helix axial direction. In some embodiments a single thread may pass from one element to another element in one direction. In other embodiments, a single thread may pass from one element to another element and then back to the first element in a loop. In some embodiments, there may be a combination of single direction threads and looping threads.

That is, the embodiments shown in FIGS. 1A-3B are meant to be exemplary. The connection of the support threads to the radiating element and the central or external support needs to be sufficient to limit the displacement of the radiating element in the axial, radial, and optionally (depending on size and shape of the radiating element), torsional directions regardless of how the support the connection is established.

In the embodiments shown in FIG. 1A-3B, the central support is designed and shaped to limit effects on RF transmission. That is the central support has a limited external surface area which both limits the weight of the central support and limits the surface area/amount of material which could interfere with the receiving and/or emitting of electromagnetic waves by the antenna. The central support can have any design which enables sufficient support to the radiating element why minimizing effects on the operation of the antenna.

The plurality of support threads 130 include three different support thread configurations: axial support threads 131, radial support threads 132, and torsional support threads 133. Axial support threads 131 manage on-axis (helical axis) movement of the radiating element by limiting displacement of the helix in the axial direction. Radial support threads 132 manage radial movement of the radiating element by limiting displacement of the helix in the radial direction. Torsional support threads 133 manage torsional movement of the radiating element by limiting displacement of the helix in the torsional direction. The directions in which each type of thread provides support is the primary direction, while, in operation, each type of thread may provide some additional support in the other directions. Only one example of each support thread configuration is labelled in FIG. 1A. The support threads 131, 132, and 133 are made of the same material but provide support in different directions.

Radiating element 110 is a conical helix wound around a central axis of the helix extending along the length of the helix (helix axis or helical axis). In other embodiments, the helix may be conical, cylindrical, or any combination thereof, or the radiating element may not have a helical shape. The central support 120 is arranged so that its long axis is collinear with the helix axis (thus giving the appearance of the helix wrapping around the central support).

The radiating element 110 may be helically shaped. The radiating element 110 may be flexible. The radiating element 110 may be manufactured—whether by matter subtraction or addition, molded or formed from a conductive material (or at least a conductive outer layer). The radiating element 110 may be wound around the central support 120.

The central support 120 may be composed of a material which allows RF waves to pass through the material or which has a negligible effect on transmission of RF waves through the material. The central support 120 may provide support to the flexible radiating element 110 during launch. The central support 120 may provide support to the flexible radiating element 110 to maintain shape of the radiating element 110 once in orbit operation. The central support 120 of FIGS. 1A-1D includes a base 121 which, in operation, is used to mount the central support on an antenna ground plane 140. The axial support threads 131 are connected to the base 121.

In FIGS. 1A-1D, the radiating element 110 and the central support 120 are a single piece. In other embodiments, however, the radiating element 110 and the central support 120 may be separate pieces.

Support threads 130 interconnect the radiating element 110 and the central support 120. The radiating element 110 includes thread interfaces 112 (two thread interfaces 112-1, 112-2 are labelled in FIG. 1A). In the embodiment of FIG. 1A-D, the thread interfaces 112 are located along the helix 110 at every sixth of a turn, i.e., every 60°. In other embodiments, the thread interfaces 112 may be more or less frequently distributed around the helix.

In FIGS. 1A-D, most of the thread interfaces 112 (with the exception of some interfaces on the bottom-most turn of the helix) have a thicker diameter or width than the rest of the helix. This thicker diameter provides support to the helix where holes are present. In other embodiments, the diameter may not be thicker where holes are present (or there may not be holes at the thread interfaces).

The helix is connected via thread interfaces 112-1 to the central support 120 by support threads 131 and 132. As discussed above, in other embodiments the connection of the threads to the radiating element and the central support may be accomplished in any number of ways. In FIGS. 1A-D, each thread interface 112-1 has three holes but this embodiment is an example. In other embodiments, the thread interface may include more or fewer holes for interacting with more or fewer threads. In other embodiments, the thread interface may not include holes.

Thread interfaces 112-2 are connected to the central support by threads 131, 132, and 133. Each thread interface 112-2 has four holes. Thread interfaces 112-1 and 112-2 alternate along the helix.

As with thread interfaces 112-1, in other embodiments thread interfaces 112-2 may include more or fewer holes, be connected to more or fewer threads, or may not have any holes.

Axial support thread 131 connects the base 121 of the central support 120 to several turns of the helical radiating element 110 along the helical axis. In FIG. 1A, the bottom eight turns (eight turns closest to the base 121) are interconnected.

In FIG. 1A, axial support thread 131 is a single continuous piece of thread which passes through holes at thread interfaces 112-1, 112-2 on the radiating element 110. In other embodiments, there may be a plurality of support threads connecting turns of the helix 110 to the turns above and below (where applicable).

In FIG. 1A, there are twelve axial support threads 131, with two threads connecting each thread interface 112 to the thread interfaces directly above and below (except for the tip-thread interface which is only connected to the thread interface below and the base-most thread interface which is only connected to the thread interface above). As discussed above, in other embodiments any number of threads may be used to create the connections necessary to support the radiating element.

Radial support thread 132 connects the radiating element 110 to the elongated element 122 of central support 120 in a radial direction. That is, each thread interface 112 of the radiating element 110 is connected to a thread interface 123 on the central support 120 which is positioned directly across from the thread interface 112-1 along a radius of the helix. In FIG. 1, there is a single radial support thread 132 for each thread interface 112.

Torsional support thread 133 (blue threads) connects the radiating element 110 to the elongated element 122 of central support 120 along the radial and torsional direction. Each thread interface 112-2 is connected to two thread interfaces 123 on the central support 120 is positioned along two different chords from the thread interface 112-2. That is, each thread interface 112-2 is connected to the thread interfaces 123 which are connected to the adjacent thread interfaces 112-1 by radial support threads 132.

Specifically, each thread interface 112-2 is connected to three thread interfaces 123 on the central support 120. For a given thread interface 112-2, a radial support thread 132 connects the thread interface 112-2 to the thread interface 123 which is along a radius of the helix from the thread interface 112-2 as described above, and one single torsional support thread 133 connects the thread interface 112-2 to each of the thread interfaces 123 which are positioned along a radius of the helix from the thread interfaces 112-1 adjacent to the thread interface 112-2 along the helix. Accordingly, half of the thread interfaces 123 are connected to a single thread interface 112-1, while the other half of the thread interfaces 123 are connected to a single thread interface 112-1 and two thread interfaces 112-2. In FIG. 1, there is a single torsional support thread 133 which passes through all thread interfaces 112-2. In other embodiments there may be more than one torsional support thread 133.

FIG. 1B is a side view of a tip segment 102 of the antenna assembly 100 of FIG. 1A. FIG. 1B shows only the antenna assembly 100 of FIG. 1A and includes a partial view of radiating element 110. Again, the radiating element support system comprises a central support 120 and a plurality of threads 130 connecting the radiating element 110 to the central support 120. The threads include axial support threads 131, radial support threads 132, and a torsional support thread 133, with only one thread of each type labelled in FIG. 1B to reduce clutter. The radiating element 110 includes thread interfaces 112 having two different types 112-1 and 112-2 (only one of each labelled to reduce clutter).

As described above for FIG. 1, axial support threads 131 pass through connections points 112 along the helical axis of radiating element 110.

Radial support thread 132 connects each of thread interfaces 112 to a thread interface 123 positioned directly across from each thread interface 112 along a radius of the helix of radiating element 110.

Torsional support thread 133 connects a given thread interface 112 to the two thread interfaces 123 which are positioned directly along the radius of the helix from the two thread interfaces 112-1 which are adjacent to the given thread interface 112-2.

Referring now to FIG. 1C, therein is shown a side view of a bottom segment 104 of antenna assembly 100 of FIG. 1A.

Referring now to FIG. 1D, therein is shown a top view of the antenna assembly 100 of FIGS. 1A-C. The antenna assembly 100 includes radiating element 110 and a radiating element support system comprising a central support 120 and a plurality of threads 130. There are three different configurations of thread: axial support threads 131, radial support threads 132, and a torsional support thread 133, with a single thread of each type being labelled in FIG. 1D.

Each thread interface 112 is connected to the thread interface above (closer to the tip) and below (closer to the base) by axial support thread 131, where applicable. The thread interfaces on the turn closest to the tip 102 of the radiating element 110 will only be connected to the thread interfaces below, and the thread interfaces on the turn closest to the bottom 104 of the radiating element 110 will only be connected to the thread interfaces above.

Each thread interface 112 is connected by a radial support thread 132 to the central support 120 at a connection which is positioned directly across from the connection 112 along a radius of the helix (the same as thread interfaces 123 of FIG. 1A-1C, but not clearly shown in FIG. 1D).

Each thread interface 112-2 is further connected by a torsional support thread 133 to the central support at two connections which are positioned directly across from the two thread interfaces 112-1 on either side of the thread interface 112-2 along the helix. In the embodiment of FIG. 1D there is only a single torsional support thread 133 connecting all thread interfaces 112-2. In other embodiments, there may be more than one torsional support thread 133.

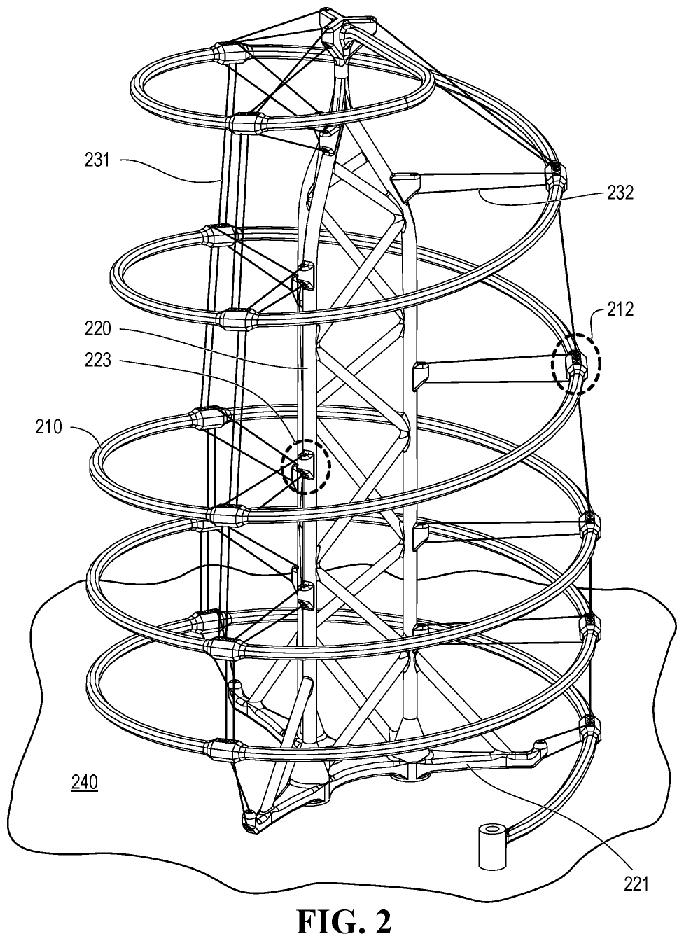

FIG. 2 is a side view of an antenna assembly 200 with a radiating element support system according to an embodiment. The antenna assembly 200 includes a radiating element 210, and a radiating element support system comprising a central support 220, and a plurality of threads 230. The plurality of threads includes two different configurations of thread: axial support threads 231 and radial support threads 232 (only one of each labelled to reduce clutter).

Antenna assembly 200 functions in a similar manner to antenna assembly 100 but is not identical. The central support 220 of antenna assembly 200 has a different design than central support 120 of FIGS. 1A-D. There are no torsional support threads in antenna assembly 200. Each turn of the helical radiating element 110 of antenna assembly 100 had six thread interfaces for connecting threads to the central support or to other thread interfaces, while the helical radiating element 210 of FIG. 2 has only three thread interfaces 212 on each turn. As there are only axial support threads 231 and radial support threads 232, the thread interfaces 212 have only three holes each.

The axial support threads 231 and the radial support threads 232 operate in the same way as in antenna assembly 100 of FIGS. 1A-1D. Axial support threads connect thread interfaces 212 positioned above/below along the helical axis. Radial support threads connect each thread interface 212 to a thread interface 223 on the central support 220 which is positioned along a radius of the helical radiating element 110 from the thread interface 212. The axial support threads 231 connect the helix to a base 221 of central support 220, which is mounted to an antenna ground plane 240.

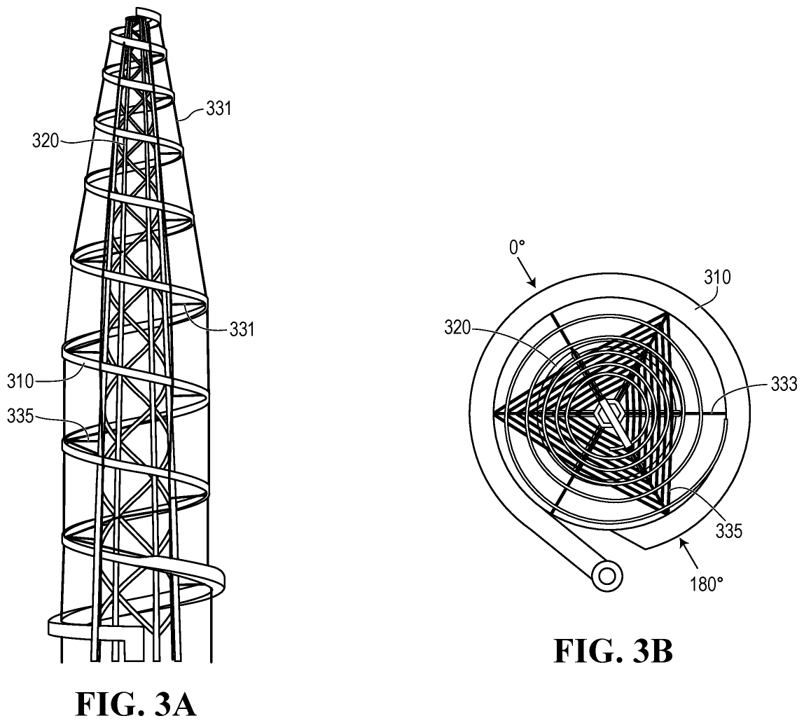

FIG. 3A is a side view of an antenna assembly with a radiating element support system 300, according to an embodiment, and FIG. 3B is a top-down view of the antenna assembly with a radiating element support system 300 of FIG. 3A.

FIG. 3A and 3B represent yet another embodiment of an antenna assembly wherein the central support 320 has a different design than central support 120 or central support 220. The helical radiating element 310 of antenna assembly 300 includes six thread interfaces for each turn of the helix (i.e., one thread interface every) 60°. The radiating element support system plurality of threads includes axial support threads and radial support threads and also torsional support threads. The axial support threads connect thread interfaces at the same location around the helix (e.g., all thread interfaces at 0°). Radial support threads connect each thread interface to the central support along a radius of the helix. Torsional support threads connect thread interfaces on the helical radiating elements directly to other thread interfaces on the helical radiating element. Specifically, every second thread interface is directly connected. That is, for example on a turn the thread interface at 0° is connected to the thread interface at 120°,the thread interface at 60° is connected to the thread interface at 180°, the thread interface at 120° is connection to the thread interface at 240°, and so on.

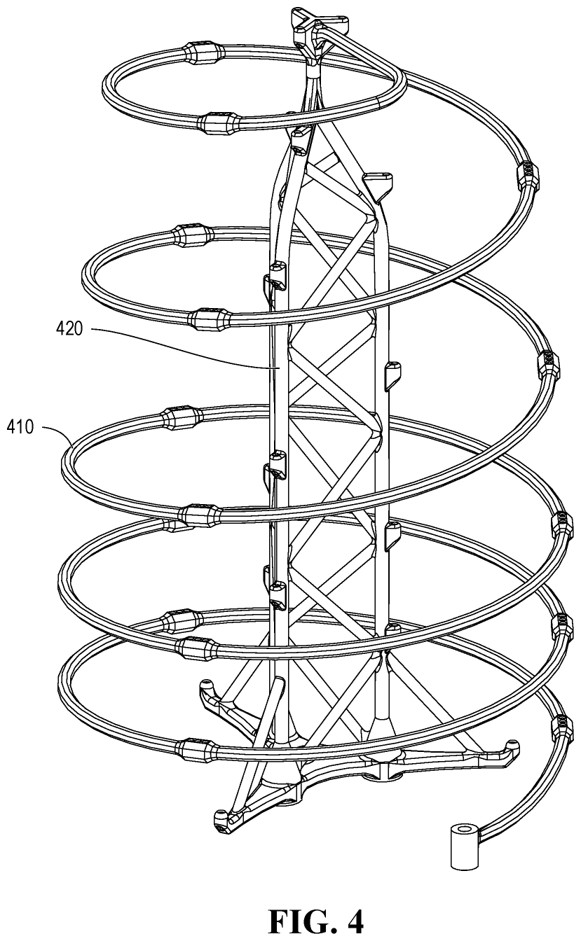

FIG. 4 is a side view of a single piece radiating element 410 and central support 420 of an antenna assembly, according to an embodiment. The central support 420 is identical to the central support 220 of FIG. 2 and similar to the central support 110 of FIGS. 1A-D. Manufacturing the radiating element 410 and central support 420 as a single piece minimizes the complexity of assembly of an antenna assembly with a radiating element support system as well as the cost. When applying or connecting the dielectric threads which comprise the radiating element support system, having fewer discrete parts to hold together simplifies the process.

The single piece radiating element 410 and central support 420 may be manufactured by 3D printing. The material used for 3D printing may be aluminum.

In some embodiments, an antenna assembly may not include a central support but a support external to the volume external to the helix. When there is no central support, the radiating element may still be 3D printed.

While the plurality of threads are being applied to the radiating element 410 the central support 420 (or in some embodiments just the radiating element), additional temporary supports may be used to ensure that the helical radiating element holds the correct shape, position, and location.

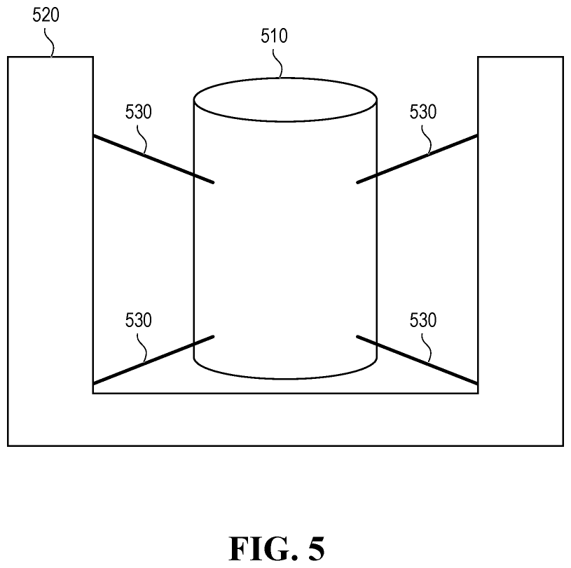

Referring now to FIG. 5, shown therein is a simplified block diagram of an antenna assembly 500 including a radiating element support system with external supports, according to an embodiment. The antenna assembly 500 may be used in an antenna configured for satellite-based communication.

The antenna assemblies of FIGS. 1A-4 included a central support. The antenna assembly 500 includes external support 520 which are connected to radiating element 510 by a support thread network 530.

In FIG. 5, the external support comprises a single cup element, which surrounds the radiating element. In other external support embodiments, the external support may comprise multiple elements, example: a plurality of pillars. In other external support embodiments, the radiating element support system may also include a central support.

The embodiments of FIGS. 1A-5 are directed towards supporting a radiating element of an antenna of a satellite. In other embodiments, other satellite payloads may be supported by a system of threads. In particular, high aspect ratio (length vs. width) components such as waveguides and struts may be supported by a thread support network to mitigate vibration modes of said components. Currently these components are supported by attaching the component to the other components of the satellite at multiple locations, but this can significantly increase mass and lead to problems such as increases in global assembly response under vibration while degrading overall performance. A thread support network can constrain these components in at least the radial direction. The threads of the thread support network may be similar to those described above.

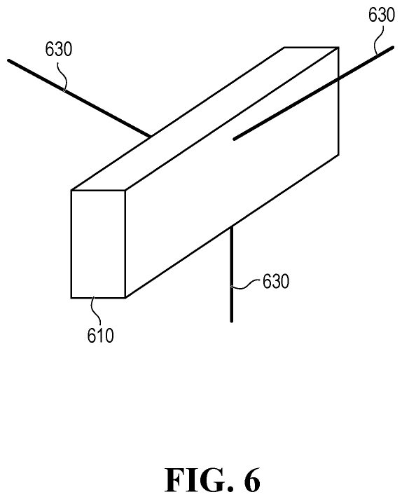

FIG. 6 is a simplified block diagram of a waveguide 610 of a satellite assembly including a waveguide thread support network 630, according to an embodiment.

The waveguide 610 is supported by three support threads of the support thread network 630. The support thread network 630 is connected to either existing components of the satellite or to supports which are added for the purpose of providing connection and support to the support thread network 630 and the waveguide 610.

In other embodiments, payloads other than a waveguide could be supported by the support thread network.

In embodiments with external supports, the external supports may be used to limit the displacement of the radiating element in any or all of the axial, radial and torsional directions.

While the above description provides examples of one or more apparatus, methods, or systems, it will be appreciated that other apparatus, methods, or systems may be within the scope of the claims as interpreted by one of skill in the art.

1. A radiating element assembly, for an antenna, comprising:
a radiating element for emitting and/or receiving electromagnetic waves;
a radiating element support system for physically supporting the radiating element when in operation, comprising:
a plurality of dielectric support threads, wherein the plurality of dielectric support threads act as non-linear structural links which interconnect the radiating element to constrain the radiating element in one or more of an axial direction, a radial direction, and a torsional direction, and wherein the plurality of dielectric support threads are taut with near zero tension; and
at least one support wherein the plurality of dielectric support threads interconnect the radiating element with the at least one support to constrain the radiating element in the one or more of the axial direction, the radial direction, and the torsional direction.

2. The radiating element assembly of claim 1, wherein the at least one support includes a central support positioned within the radiating element.

3. The radiating element assembly of claim 2 wherein the central support is fixed to a ground plane at a base of the antenna.

4. The radiating element assembly of claim 2 wherein the central support is rigid in tension, compression, bending, and torsion.

5. The radiating element assembly of claim 1, wherein the at least one support includes at least one external support positioned external to the radiating element.

6. The radiating element assembly of claim 1, wherein the at least one support includes a central support within the radiating element and at least one external support position external to the radiating element.

7. The radiating element assembly of claim 1, wherein the radiating element and the central support are manufactured as a single piece.

8. The radiating element assembly of claim 1, wherein the radiating element is helical.

9. The radiating element assembly of claim 1 wherein the radiating element is flexible due to a shape of the radiating element.

10. The radiating element assembly of claim 1 wherein the radiating element support system prevents movement of the radiating element beyond a correct nominal position.

11. The radiating element assembly of claim 1 wherein each of the dielectric support threads has a thread diameter in the range of 0.005 to 0.050 inches.

12. The radiating element assembly of claim 1 wherein the dielectric support threads comprise a radiofrequency (RF) transparent material.

13. The radiating element assembly of claim 1 wherein the dielectric support threads comprise glass or aramid fibers.

14. The radiating element assembly of claim 1, wherein each dielectric support thread comprises two or more strands twisted together.

15. A satellite payload assembly, comprising:
a payload of a satellite;
a payload support system for physically supporting the payload, comprising:
a plurality of dielectric support threads, wherein the plurality of dielectric support threads act as non-linear structural links which interconnect the payload to constrain the payload in one or more of a radial direction, a torsional direction, and an axial direction, and wherein the plurality of dielectric support threads are taut with near zero tension; and
at least one support, wherein the plurality of dielectric support threads interconnect the payload with the at least one support to constrain the payload in the one or more of the radial direction, the torsional direction, and the axial direction.

16. The satellite payload assembly of claim 15, wherein the at least one support includes a central support positioned within the payload.

17. The satellite payload assembly of claim 16 wherein the central support is fixed to a ground plane at a base of the payload.

18. The satellite payload assembly of claim 15, wherein the at least one support includes at least one external support positioned external to the payload.

19. The satellite payload assembly of claim 15, wherein the at least one support includes a central support within the payload and at least one external support position external to the payload.

20. The satellite payload assembly of claim 15 wherein the payload is a waveguide.
